(19) United States
(12) Patent Application Publication
(10) Pub. No.: US 2019/0303437 A1
(43) Pub. Date: Oct. 3, 2019

(54) STATUS REPORTING WITH NATURAL LANGUAGE PROCESSING RISK ASSESSMENT

(71) Applicant: Konica Minolta Laboratory U.S.A., Inc., San Mateo, CA (US)

(72) Inventors: Stuart Guarnieri, Laramie, WY (US); Markus Maresch, Hausmannstätten (AT); Timothy Louis McCann, JR., Longmont, CO (US)

(73) Assignee: Konica Minolta Laboratory U.S.A., Inc., San Mateo, CA (US)

(21) Appl. No.: 15/938,811

(22) Filed: Mar. 28, 2018

(51) Int. Cl. G06F 17/27

(52) U.S. Cl. CPC G06F 17/2785; G06F 17/274; G06F 17/2705

(57) ABSTRACT

A method is provided for generating a status report including risk assessment based on Natural Language Processing (NLP). The method includes: receiving a task status that includes a line of text; parsing the line of text to generate a mark-up version of the line of text; calculating a sentence score of the mark-up version of the line of text; calculating an overall score of the task status based on the sentence score; storing the task status including the mark-up version of the line of text and the sentence and overall score; receiving a status report generation request that includes a search criteria; retrieving the task status and the sentence and overall scores associated with the search criteria; calculating a highlighting color of the task status based on the sentence score; and generating the status report including a highlighted task status based on the highlighting color and the task status.

### BACKGROUND

Natural Language Processing (NLP), in combination with artificial intelligence that enables self-learning, utilizes different processing methods (e.g., speech recognition, natural-language understanding, and natural language generation, etc.) that allow computers to mimic how humans process natural human languages (e.g., English, Spanish, Chinese, Japanese, Hindi, etc.).

Status reports by individual contributors in a business (e.g., a company, a restaurant, a hotel, etc.) provide a plethora of information (e.g., state and status of a project/assignment, a product, an employee, etc. at the business) for decision makers (e.g. managers, supervisors, etc.) at the business. Often, decision makers will not have time to consider every bit of information included in the status reports. Furthermore, the determination of a risk and importance of each piece of information included in the status reports are dependent on the individual contributors and the decision makers, which may return biased results. Regardless, users (e.g., the decision makers) still wish to be able to quickly ascertain the risk and importance (i.e., asses the risk and importance) of each piece of information without heavy reliance on the on the individual contributors and the decision makers.

### SUMMARY

In general, in one aspect, the invention relates to a method for generating a status report including risk assessment based on Natural Language Processing (NLP). The method comprising: receiving a task status that includes a line of text; parsing the line of text to generate a mark-up version of the line of text; calculating a sentence score of the mark-up version of the line of text; calculating an overall score of the task status based on the sentence score; storing, in a memory, the task status including the mark-up version of the line of text, the sentence scores, and the overall score; receiving a generation request for the status report, wherein the generation request comprises a search criteria; retrieving, in response to determining that the task status is associated with the search criteria, the task status, the sentence score, and the overall score from the memory; calculating a highlighting color of the task status based on the sentence score; generating the status report including a highlighted task status based on the highlighting color and the task status; and displaying the status report on a display.

In general, in one aspect, the invention relates to a non-transitory computer readable medium (CRM) storing computer readable program code for generating a status report including risk assessment based on Natural Language Processing (NLP) embodied therein. The computer readable program code causes a computer to: receive a task status that includes a line of text; parse the line of text to generate a mark-up version of the line of text; calculate a sentence score of the mark-up version of the line of text; calculate an overall score of the task status based on the sentence score; store, in a memory, the task status including the mark-up version of the line of text, the sentence scores, and the overall score; receive a generation request for the status report, wherein the generation request comprises a search criteria; retrieve, in response to determining that the task status is associated with the search criteria, the task status, the sentence score, and the overall score from the memory; calculate a highlighting color of the task status based on the sentence score; generate the status report including a highlighted task status based on the highlighting color and the task status; and display the status report on a display.

In general, in one aspect, the invention relates to a system for generating a status report including risk assessment based on Natural Language Processing (NLP). The system comprising: a memory; and a computer processor connected to the memory. The computer processor: receives a task status that includes a line of text; parses the line of text to generate a mark-up version of the line of text; calculates a sentence score of the mark-up version of the line of text; calculates an overall score of the task status based on the sentence score; stores, in a memory, the task status including the mark-up version of the line of text, the sentence scores, and the overall score; receives a generation request for the status report, wherein the generation request comprises a search criteria; retrieves, in response to determining that the task status is associated with the search criteria, the task status, the sentence score, and the overall score from the memory; calculates a highlighting color of the task status based on the sentence score; generates the status report including a highlighted task status based on the highlighting color and the task status; and displays the status report on a display.

Other aspects of the invention will be apparent from the following description and the appended claims.

### BRIEF DESCRIPTION OF DRAWINGS

FIG. 1 shows a system in accordance with one or more embodiments of the invention.

FIGS. 2A and 2B show flowcharts in accordance with one or more embodiments of the invention.

FIGS. 3A-3E show implementation examples in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method, a non-transitory computer readable medium (CRM), and a system for generating a status report including risk assessment based on Natural Language Processing (NLP). Specifically, task statuses including one or more lines of texts that are input by individual contributors are parsed and processed using different NLP methods to split each line of text and to generate a sentence score for each line of text. A risk score (i.e., an overall score) that determines a severity of a risk and/or an importance of each task status is calculated for each task status based on the sentence scores. A status report is generated with one or more lines of text that convey the most relevant or important information to a user (e.g., a decision maker) highlighted with a color associated with the risk score. The status report is displayed to the user on a display for the user to easily and efficiently evaluate each task status included in the report.

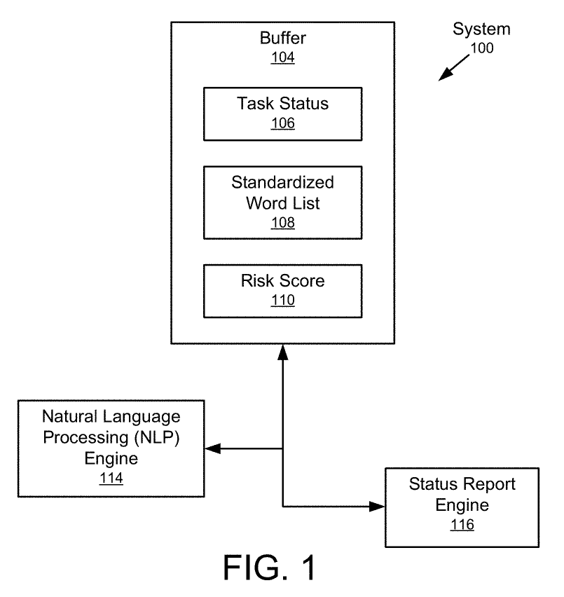

FIG. 1 shows a system (100) in accordance with one or more embodiments of the invention. As shown in FIG. 1, the system (100) has multiple components, including, for example, a buffer (104), a natural processing language (NLP) engine (114), and a status report engine (116). Each of these components (104, 114 and 116) may be located on the same computing device (e.g., personal computer (PC), laptop, tablet PC, smart phone, multifunction printer, kiosk, server, etc.) or on different computing devices connected by a network of any size having wired and/or wireless segments. Each of these components is discussed below.

In one or more embodiments of the invention, the buffer (104) may be implemented in hardware (i.e., circuitry), software, or any combination thereof. The buffer (104) is configured to store a task status (106), a standardized word list (108), and a risk score (110) of the task status (106). In one or more embodiments, multiple task statuses (106) and risk scores (110) may be stored in the buffer (108).

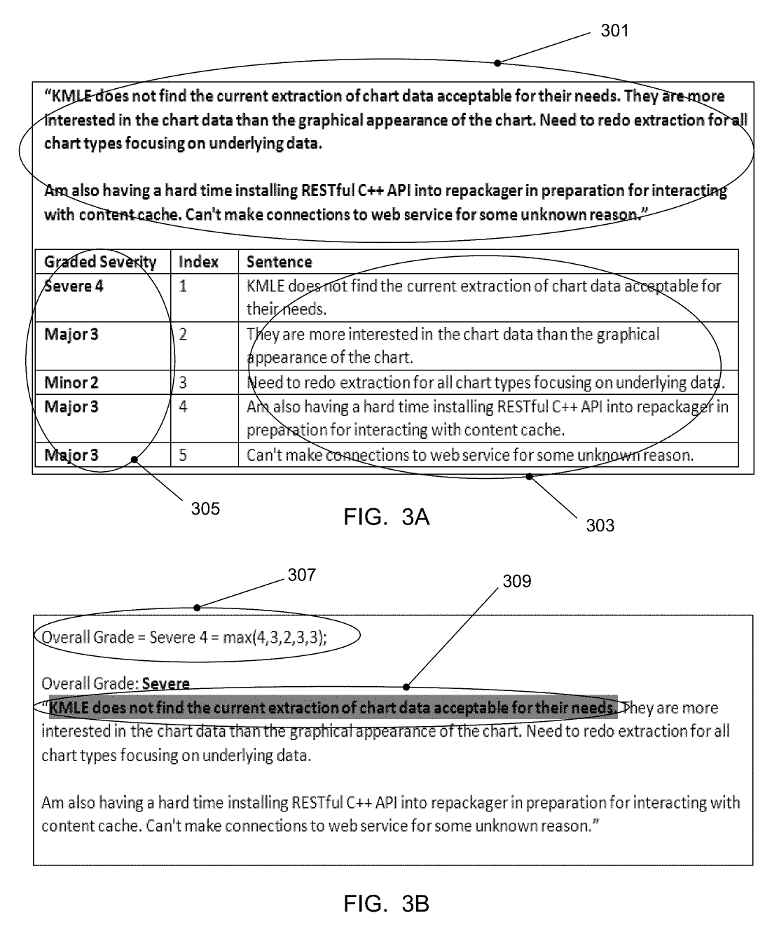

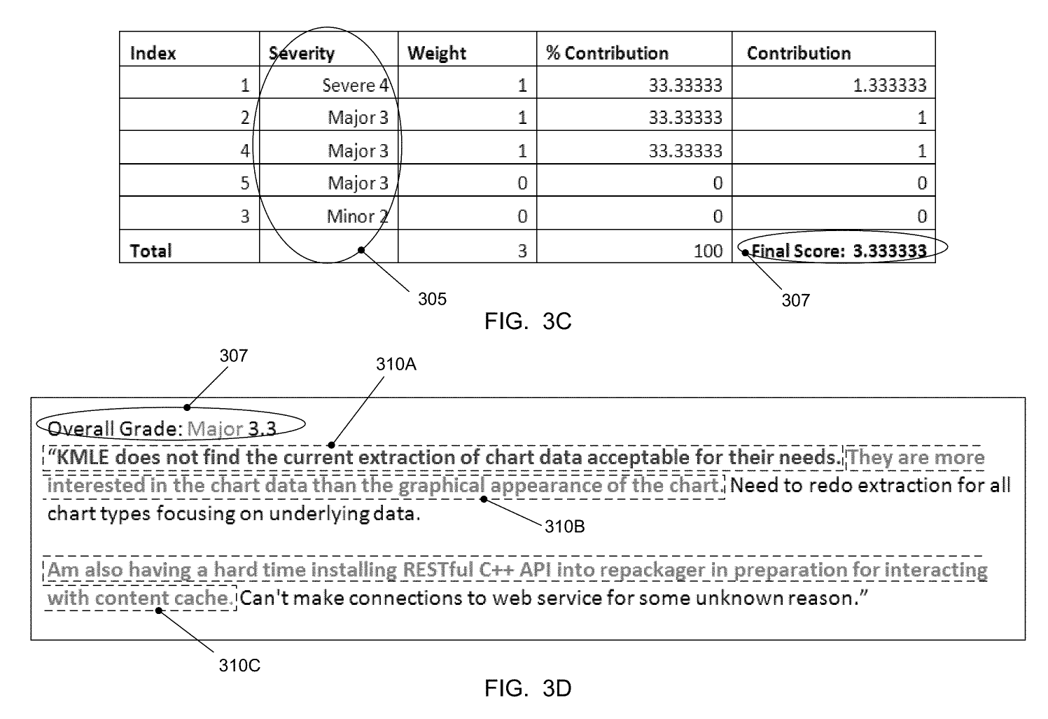

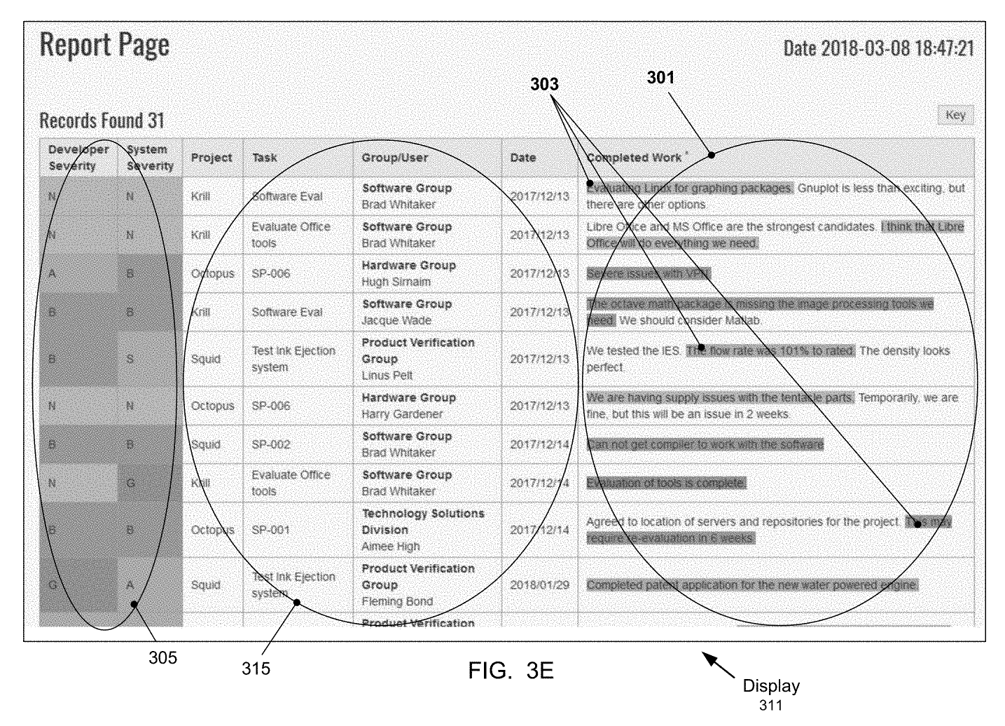

In one or more embodiments of the invention, the task status (106) may include one or more lines of text that describe a task description (e.g. a status and/or a state of a project, assignment, product, and personnel, etc.). The task status (106) may be obtained (e.g., downloaded, input, parsed, etc.) from any source (e.g., a web interface, email, input files, etc.). Each task status (106) may include task information such as a date of input, a task identifier (task ID) that identifies the lines of text as a text status, and the task description. In one or more embodiments, the task information may further include a project identifier (project ID) associated with the task description, a user identification (user ID) that identifies the user who generated the task status (106), a group identification (group ID) that identifies a group or team in the business associated with the task description, a division identification (division ID) that identifies a division within a business associated with the task, etc. This is exemplified in more detail below with reference to FIG. 3E.

In one or more embodiments of the invention, the contents of the standardized word list (108) may be obtained (e.g., downloaded, imported, etc.) from any source. More specifically, the standardized word list (108) may be a list of standardized words obtained from one or more dictionary databases that includes words and phrases that are commonly used in formal speech.

In one or more embodiments of the invention, the NLP engine (114) may be implemented in hardware (i.e., circuitry), software, or any combination thereof. In one or more embodiments, the NLP engine (114) parses the task status (106) to extract and separate each line of text associated with the task status (106). In one or more embodiments, the task status (106) may be stored into the buffer (104) once each line of text has been extracted and separated. Alternatively, the task status (106) may be stored into the buffer (104) at any time. In one more embodiments, the NLP engine (114) may be configured with any suitable NLP method.

For example, in one or more embodiments, the NLP engine (114) may be configured to store instructions to perform known NLP methods such as natural language generation, morphological segmentation, sentence parsing, sentence breaking, word segmentation, sentiment analysis, terminology extraction, semantic search, named entity recognition (NER), machine learning, natural language programming, etc. that are used to process, interpret, and produce natural human languages (e.g., English, Spanish, Chinese, Japanese, Hindi, etc.).

In one or more embodiments of the invention, the NLP engine (114) may prepare each of the separated lines of text prior to executing any one or a combination of the above listed NLP methods on the lines of text (i.e., prepares each of the separated lines of text for further processing). The preparation of each line of text may include a substitution of contracted (i.e., shortened) and/or sensitive words with a standardized word from the standardized word list (108), removal of leading and trailing punctuations, changing uppercase letters to lowercase letters, etc. This prepares each line of text in the task status (106) for further processing by removing slangs (e.g., words and phrases that are regarded as very informal) to formalize the language and remove contents (e.g., punctuations, uppercase characters, etc.) that may result in a biased evaluation of each line of text. In other words, each line of text is prepared to ensure that the best data is being evaluated by the NLP engine (114). For example, assume that a line of text in a text status reads: “This project ain't EVER going to succeed.” The sentence resulting from the preparation (i.e., a mark-up version of the line of text) may read: this project is not ever going to succeed. In one or more embodiments, the preparation of the lines of text for NLP may be performed using any suitable character recognition methods, word processing methods, etc. and is not limited to the example preparations above.

In one or more embodiments of the invention, the NLP engine (114) may utilize any one or a combination of the above listed NLP methods to perform a scoring of each line of text in the task status (106) to calculate a sentence score for each line of text. The sentence score may be a numerical value (e.g., an integer, a real number, a floating point number, etc.), an alphabetical character, or a combination of both that represents a severity of a risk and/or importance of the task description in each line of text. For example, a severity level scale of 0 to 4 may be established for the sentence scores with “0” being no risk and “4” being highest severity (i.e., highest risk). This is exemplified in more detail below with reference to FIGS. 3A and 3C.

In one or more embodiments of the invention, the calculation of the sentence scores may be performed using any suitable method such as Bag of Word style scoring, Recurrent Neutral Network (RNN) based Sentiment Analysis, etc. In one or more embodiments, the NLP engine (114) may also be trained to calculate the sentence scores based on a corpus of words, phrases, and sentences that are graded (i.e., graded examples of words, phrases, and sentences) that may be stored in the buffer (104). In other words, the NLP engine (114) may be constantly learning (e.g., automatically updating, improving, and/or refining its own performance) through training.

In one or more embodiments of the invention, the NLP engine (114) may utilize any one or a combination of the above listed NLP methods to calculate the risk score (i.e., the overall score) (110) for the task status (106) based on the sentence scores of each line of text associated with the text status (106). In one or more embodiments, the risk score (110) represents the overall risk and/or importance of the task status (106).

In one or more embodiments of the invention, the risk score (110) may be determined by identifying a maximum score (i.e., the risk score (110) that indicates a highest severity (i.e., highest risk)) within all of the sentence scores of a task status (106). Alternatively, the risk score (110) may be calculated using a weighted combination of all of the sentence scores of the task status (106). For example, the sentence scores are ordered by severity from highest severity (i.e., highest risk) to lowest severity (i.e., lowest risk). The top N % of the sentence scores may be selected. A predetermined weight value may be assigned to each of the top N % lines of text where the highest line of text may be assigned a weight of X and the lowest line of text may be assigned a weight of Y. All lines of text in between are linearly scaled based on X and Y. All lines of text outside the top N % are assigned a weight of 0. In one or more embodiments, X, Y, and N, may be any integer that is pre-set by a user. This is exemplified in more detail below with reference to FIG. 3C.

The method for calculating the risk score (110) is not limited to the examples described above. In one or more embodiments, other methods that take into account the distribution of the sentence scores to calculate a value that represents an overall severity of the risk and/or importance of the task status (106) may be used to calculate the risk score (110).

In one or more embodiments of the invention, the NLP engine (114) may store the calculated risk score (110) of the task status (106) along with the task status (106) in the buffer (104) such that the risk score (110) is associated with the task status (106). In one or more embodiments, the sentence scores may also be stored in the buffer (104).

In one or more embodiments of the invention, the risk score (110) may be stored with the remaining task information as a tag of the task status (106). Alternatively or in addition, the risk score (110) may be stored with the remaining task information in a metadata of the task status (106).

In one or more embodiments of the invention, the status report engine (116) may be implemented in hardware (i.e., circuitry), software, or any combination thereof. In one or more embodiments, the status report engine (116) generates a status report based on a status report generation request received from a user and the task statuses (106) and risk scores (110) stored in the buffer.

In one or more embodiments of the invention, the status report engine (116) parses a status report generation request received from a user to extract one or more search criterion included in the status report generation request. The status report engine (116) may generate a search filter based on the one or more search criterion for retrieving data (i.e., task statuses (106)) from the buffer (104). The search filter may compare the one or more search criterion to the task information stored with each task status (106) to determine which task statuses (106) should be retrieved for the generation of the status report. In one or more embodiments, the status report engine (116) retrieves all task statuses (106) determined to be associated with the status report generation request.

In one or more embodiments of the invention, the status report engine (116) calculates a highlighting and/or font color for each task status (106). The highlighting and/or font color may represent a severity of a risk and/or importance of each task status (106) and may be based on the sentence score of each line of text in the task status (106). For example, assume that red is a color commonly associated with a highest severity (i.e., highest risk), highlighting or font color of red will be calculated for task statuses (106) with task descriptions that indicate a highest severity (i.e., highest risk). In one or more embodiments, any suitable color scheme for the highlighting and/or font color may be applied to illustrate a risk and/or importance of the task status (106). In one or more embodiments, when both the highlighting and font colors are applied to a task status (106), different colors may be chosen for the highlighting and font colors to prevent the two from cancelling one another out (e.g., overlapping in color when the same color is selected for both the highlighting and font colors, obscuring one or the other when the selected color is too close in shading, etc.).

In one or more embodiments of the invention, the status report engine (116) may apply the highlighting and/or font color to one or more lines of text of the task status (106). In one or more embodiments, the highlighting and/or font color may be applied to all of the lines of text in a task status (106). Alternatively, the highlighting and/or font color may be applied to only lines of text with the highest severity (i.e., highest risk) sentence score. As a further alternative, the highlighting and/or font color may be applied to only the first-occurring line of text with the highest severity (i.e., highest risk) sentence score (i.e., the first line of text in a task status (106) with the highest severity (i.e., highest risk) sentence score). As a further alternative, the highlighting and/or font color may be applied to only the top N % of lines of text in the text status (106). This is exemplified in more detail below with reference to FIGS. 3B and 3D.

In one or more embodiments of the invention, the status report engine (116) generates a status report that includes the retrieved task statuses (106) with the highlighting and/or font color applied to each task status (106). In one or more embodiments, the status report engine (116) displays the status report on a display to the user.

Although the system (100) is shown as having three components (104, 114, 116), in other embodiments of the invention, the system (100) may have more or fewer components. Further, the functionality of each component described above may be split across components. Further still, each component (104, 114, 116) may be utilized multiple times to carry out an iterative operation.

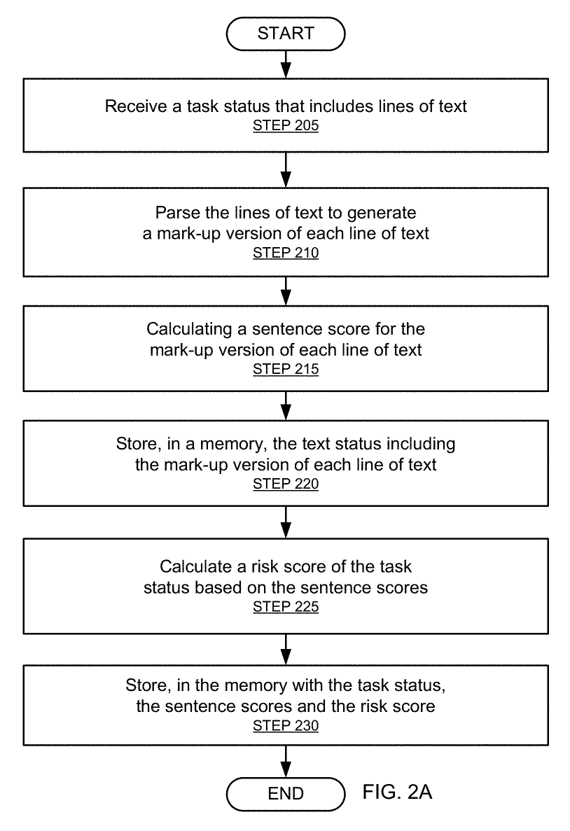

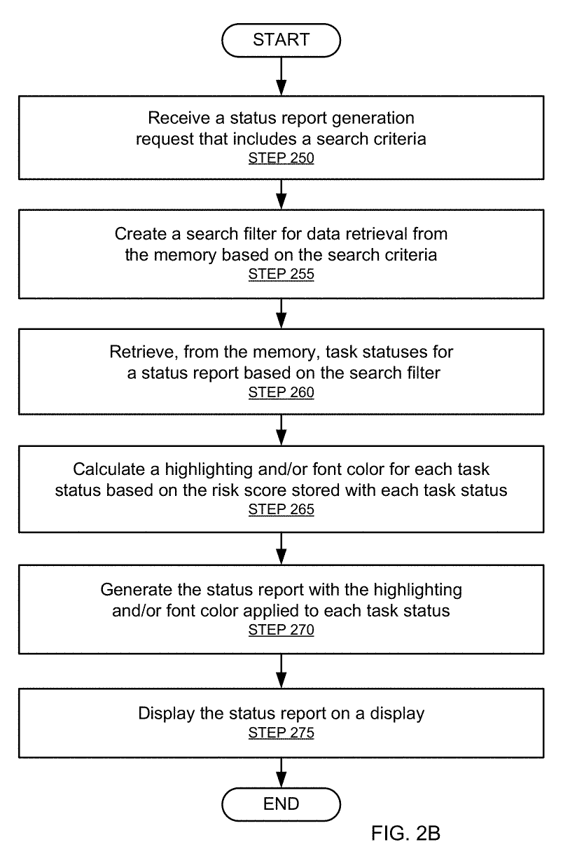

FIGS. 2A-2B show flowcharts in accordance with one or more embodiments of the invention. The flowcharts depict a process for generating a status report including risk assessment based on NLP. More specifically, FIG. 2A shows a process for receiving, processing, and storing task statuses (i.e., a data input side) and FIG. 2B shows a process for generating the status report (i.e., a data output side). One or more of the steps in FIGS. 2A-2B may be performed by the components of the system (100), discussed above in reference to FIG. 1. In one or more embodiments of the invention, one or more of the steps shown in FIGS. 2A-2B may be omitted, repeated, and/or performed in a different order than the order shown in FIGS. 2A-2B. Accordingly, the scope of the invention should not be considered limited to the specific arrangement of steps shown in FIGS. 2A-2B.

Referring to FIG. 2A, as discussed above in reference to FIG. 1, a task status including one or more lines of text is obtained (STEP 205). The task status may be obtained (e.g., downloaded, input, parsed, etc.) from any source (e.g., a web interface, email, input files, etc.).

In STEP 210, as discussed above in reference to FIG. 1, the task status is parsed to generate a mark-up version of each line of text (herein referred to as “marked-up line of text”) in the task status.

In STEP 215, as discussed above in reference to FIG. 1, a sentence score is calculated for each of the marked-up lines of text.

In STEP 220, as discussed above in reference to FIG. 1, the text status including each of the marked-up lines of text is stored in a memory (i.e., the buffer (104)).

In STEP 225, as discussed above in reference to FIG. 1, a risk score is calculated for the task status based on the sentence score of each marked-up lines of text.

In STEP 230, as discussed above in reference to FIG. 1, the calculated risk score is stored in the memory with the task status .

Referring to FIG. 2B, as discussed above in reference to FIG. 1, a status report generation including one or more search criterion is received (STEP 250).

In STEP 255, as discussed above in reference to FIG. 1, a search filter for data (i.e., task status) retrieval from the memory is created based on the one or more search criterion.

In STEP 260, as discussed above in reference to FIG. 1, task statuses are retrieved from the memory based on the one or more search criterion.

In STEP 265, as discussed above in reference to FIG. 1, a highlighting and/or font color is calculated for the marked-up lines of text in each retrieved task status based on the sentence scores.

In STEP 270, as discussed above in reference to FIG. 1, a status report is generated with the highlighting and/or font color applied to one or more of the marked-up lines of text in each of the retrieved task statuses.

In STEP 275, as discussed above in reference to FIG. 1, the generated status report is displayed on a display to a user.

FIGS. 3A-3E show implementation examples in accordance with one or more embodiments of the invention. In one or more embodiments, the example status report with NLP risk assessment generation method described above in reference to FIGS. 1 and 2A-2B are applied in the implementation example shown in FIGS. 3A-3E.

FIG. 3A shows an example of a task status (301) input by a user (e.g., the individual contributors) into the system (100) described above in reference to FIG. 1. As seen in FIG. 3A, the task status (301) includes multiple lines of text (303) that represent task descriptions. Additionally, the task status (301) has been processed by NLP and sentence scores (305) have been calculated for each line of text (303). In the example according to one or more embodiments shown in FIG. 3A, a sentence score (305) of “4” represents a highest severity (i.e., highest risk) while a sentence score (305) of “0” represents no risk. All the sentence scores (305) in between are scaled.

FIG. 3B shows a result of the calculated risk score (307) and an implementation of a highlighting (309) for the task status (301) shown in FIG. 3A. As seen in FIG. 3B, the risk score (307) is calculated based on selecting the highest severity (i.e., highest risk) sentence score (305) out of all of the sentence scores (305). As further seen in FIG. 3B, only the line of text (303) with the highest severity (i.e., highest risk) sentence score (305) is applied with the highlighting (309).

FIG. 3C shows another example of a calculation for the risk score (307) of the task status (301) shown in FIG. 3A. In the example according to one or more embodiments shown in FIG. 3C, the lines of texts (303) shown in FIG. 3A are ordered, based on the sentence scores (305), from highest severity (i.e., highest risk) to lowest severity (i.e., lowest risk). The top 60% of the lines of texts (303) are selected to calculate the risk score (307). This risk score (307) is based on a linearly-weighted contribution of the sentence scores (305).

FIG. 3D shows a result of the font color application (i.e., font-color-applied lines of text) (310A-310C) based on the risk score (307) calculation method as shown in FIG. 3C. As seen in FIG. 3D, the top 60% of the lines of text (303) selected in FIG. 3C are applied with a different font color to generate the font-color-applied lines of text (310A-310C). The font colors that is applied to the font-color-applied line of text (310A) is different from the font color applied to the font-color-applied line of text (310B, 310C), and is based on the sentence score of each font-color applied lines of text (310A-310C).

FIG. 3E shows a portion of an example status report displayed to a user on a display (311). As seen in FIG. 3E, the status report includes task statuses (301) with lines of text (303) applied with highlighting. Each task status (301) is given a risk score (305) assigned by individual contributors and/or decision makers (left column) and a risk score (305) generated using the status report generation method (right column) as described above in reference to FIGS. 1 and 2. Each of these risk scores (305) are highlighted with the same color scheme used for the highlighted lines of text (303). As seen in FIG. 3E, some risk scores (305) in the left and right columns of a same task status (301) may be different. This is result of the risk scores being determined either dependent (left column) or independent (right column) of input from the individual contributors and/or decision makers.

As further seen in FIG. 3E, the status report includes columns that represent task information (315) associated with the task statuses (301). These task information (315) are used to associate the task statuses (301) with one or more search criterion included in a search filter generated for retrieving the task statuses (301) from the memory when a status report generation request is received from a user.

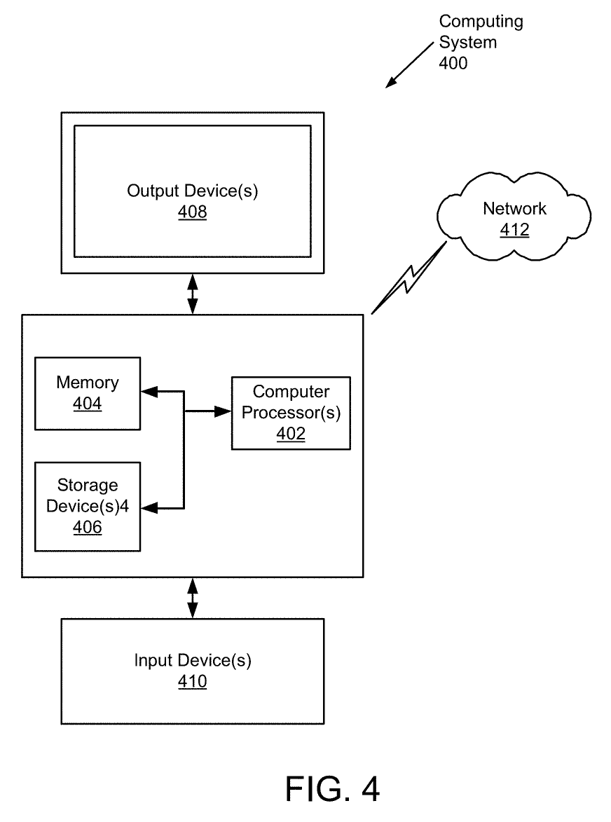

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and be connected to the other elements over a network (412). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

One or more embodiments of the invention may have one or more of the following advantages: the ability to increase the processing resources of central processing unit (CPU) (i.e., a processor) by preventing the unnecessary use of processing resources for the printing of electronic documents (ED) that cannot be used by a user (i.e., the EDs with overlapped objects); etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a status report including risk assessment based on Natural Language Processing (NLP), the method comprising:
receiving a task status that includes a line of text;
parsing the line of text to generate a mark-up version of the line of text;
calculating a sentence score of the mark-up version of the line of text;
calculating an overall score of the task status based on the sentence score;
storing, in a memory, the task status including the mark-up version of the line of text, the sentence scores, and the overall score;
receiving a generation request for the status report, wherein the generation request comprises a search criteria;
retrieving, in response to determining that the task status is associated with the search criteria, the task status, the sentence score, and the overall score from the memory;
calculating a highlighting color of the task status based on the sentence score;
generating the status report including a highlighted task status based on the highlighting color and the task status; and
displaying the status report on a display.

2. The method of claim 1, wherein
the task status is stored in the memory before being parsed, and
the task status stored in the memory is updated with the sentence score and the overall score after the sentence score and the overall score are calculated.

3. The method of claim 1, wherein
the line of text includes characters that represent a plurality of words, spaces, and punctuations, and
the parsing of the line of text to generate a mark-up version of the line of text further comprises:
substituting at least one of the words with a standardized word stored in the memory;
removing the punctuations and the spaces; and
replacing upper-case characters with lower-case characters,
wherein the substituted word is at least one of a contracted word or a sensitive word.

4. The method of claim 1, wherein
the task status further comprises task information;
determining that the task status is associated with the search criteria comprises:
comparing the task information with the search criteria; and
in response to the task information matching the search criteria, associating the task status with the search criteria.

5. The method of claim 1, wherein
the task status includes a plurality of the line of text, and
each of the lines of text includes the sentence score.

6. The method of claim 5, further comprising:
comparing the sentence score of each of the lines of text to determine a maximum sentence score, wherein
the overall score of the task status is based on the maximum sentence score.

7. The method of claim 6, wherein only lines of text with the maximum sentence score are highlighted in the status report.

8. The method of claim 6, further comprises:
identifying a sequence of the lines of text;
comparing the sentence score and the sequence of the lines of text to determine a first occurring line of text with the maximum sentence score, wherein
the sequence of the lines of text is determined by the parsing using the NLP, and
only the first occurring line of text with the maximum sentence score is highlighted in the status report.

9. The method of claim 3, further comprising:
ordering the lines of text based on the sentence score of the lines of text;
selecting a predetermined number of the lines of text based on the ordering;
assigning a weighted sentence score to each of the lines of text based on the sentence score of each of the lines of text; and
calculating the overall score of the task input based on a sum of the weighted scores,
wherein all of the selected lines of text are highlighted in the status report.

10. The method of claim 1, wherein the highlighting color represents a severity level of the line of text.

11. A non-transitory computer readable medium (CRM) storing computer readable program code for generating a status report including risk assessment based on Natural Language Processing (NLP) embodied therein, the computer readable program code causes a computer to:
receive a task status that includes a line of text;
parse the line of text to generate a mark-up version of the line of text;
calculate a sentence score of the mark-up version of the line of text;
calculate an overall score of the task status based on the sentence score;
store, in a memory, the task status including the mark-up version of the line of text, the sentence scores, and the overall score;
receive a generation request for the status report, wherein the generation request comprises a search criteria;
retrieve, in response to determining that the task status is associated with the search criteria, the task status, the sentence score, and the overall score from the memory;
calculate a highlighting color of the task status based on the sentence score;
generate the status report including a highlighted task status based on the highlighting color and the task status; and
display the status report on a display.

12. The CRM of claim 11, wherein
the task status is stored in the memory before being parsed, and
the task status stored in the memory is updated with the sentence score and the overall score after the sentence score and the overall score are calculated.

13. The CRM of claim 11, wherein
the line of text includes characters that represent a plurality of words, spaces, and punctuations, and
the parsing of the line of text to generate a mark-up version of the line of text further comprises:
substituting at least one of the words with a standardized word stored in the memory;
removing the punctuations and the spaces; and
replacing upper-case characters with lower-case characters,
wherein the substituted word is at least one of a contracted word or a sensitive word.

14. The CRM of claim 11, wherein
the task status further comprises task information;
determining that the task status is associated with the search criteria comprises:
comparing the task information with the search criteria; and
in response to the task information matching the search criteria, associating the task status with the search criteria.

15. The CRM of claim 11, wherein
the task status includes a plurality of the line of text,
each of the lines of text includes the sentence score, and
the computer readable program code further causes a computer to:
compare the sentence score of each of the lines of text to determine a maximum sentence score, wherein the overall score of the task status is based on the maximum sentence score.

16. A system for generating a status report including risk assessment based on Natural Language Processing (NLP), the system comprising:
a memory; and
a computer processor connected to the memory, wherein
the computer processor:
receives a task status that includes a line of text;
parses the line of text to generate a mark-up version of the line of text;
calculates a sentence score of the mark-up version of the line of text;
calculates an overall score of the task status based on the sentence score;
stores, in a memory, the task status including the mark-up version of the line of text, the sentence scores, and the overall score;
receives a generation request for the status report, wherein the generation request comprises a search criteria;
retrieves, in response to determining that the task status is associated with the search criteria, the task status, the sentence score, and the overall score from the memory;
calculates a highlighting color of the task status based on the sentence score;
generates the status report including a highlighted task status based on the highlighting color and the task status; and
displays the status report on a display.

17. The system of claim 16, wherein
the task status is stored in the memory before being parsed, and
the task status stored in the memory is updated with the sentence score and the overall score after the sentence score and the overall score are calculated.

18. The system of claim 16, wherein
the line of text includes characters that represent a plurality of words, spaces, and punctuations, and
the parsing of the line of text to generate a mark-up version of the line of text further comprises:
substituting at least one of the words with a standardized word stored in the memory;
removing the punctuations and the spaces; and
replacing upper-case characters with lower-case characters,
wherein the substituted word is at least one of a contracted word or a sensitive word.

19. The system of claim 16, wherein
the task status further comprises task information;
determining that the task status is associated with the search criteria comprises:
comparing the task information with the search criteria; and
in response to the task information matching the search criteria, associating the task status with the search criteria.

20. The system of claim 16, wherein
the task status includes a plurality of the line of text,
each of the lines of text includes the sentence score, and
the computer readable program code further causes a computer to:
compare the sentence score of each of the lines of text to determine a maximum sentence score, wherein the overall score of the task status is based on the maximum sentence score.
